(19) United States
(12) Patent Application Publication
(10) Pub. No.: US 2011/0145041 A1
(43) Pub. Date: Jun. 16, 2011

(54) SYSTEM FOR COMMUNICATION BETWEEN USERS AND GLOBAL MEDIA-COMMUNICATION NETWORK

(75) Inventors: Yuri Salamatov, Krasnoyarsk (RU); Vadim Zamuraev, Verkhnyaya Salda (RU); Alexander Ivanov, Moscow (RU)

(73) Assignee: InnovatioNet, Palo Alto, CA (US)

(21) Appl. No.: 13/027,910

(22) Filed: Feb. 15, 2011

(51) Int. Cl. G06Q 30/00; G06Q 40/00; G06Q 10/00

(52) U.S. Cl. 705/7.35; 705/1.1; 705/39; 705/26.1

(57) ABSTRACT

A system of communication between users via a global media-communication network including a subsystem for storage and playback of media-products, a subsystem for defining an emotional profile of a user, a subsystem for user feedback and playback of media-products in real time mode, a subsystem for storage of chosen preferences, a subsystem for fixing and storage of changes in emotional state, a subsystem for correcting of an emotional state; a subsystem for finding other users with similar emotional profile, a subsystem for forming of the image of user's face; a subsystem for defining a degree of emotional satiation of the user, a subsystem for forming and a typical day of the user, a subsystem for processing data associated with emotional features of a virtual village, a subsystem for calculation of ratings of authors and entertainment services, a subsystem for calculation of revenues of the owner of entertainment service and payments to an author, a subsystem of forecasting and planning costs of the future entertainment services, a subsystem for offering new services to the consumer, a subsystem for a direct media-channel between the artist and consumer in real time mode, a subsystem of revealing and forecasting needs of the user, and a subsystem for controlling the speed and content of transmitting a media product.

### FIELD

This application relates to a method and system of interaction between users and global-communication network.

### BACKGROUND

Today media is one of the important spheres in life of people around the world. All media production (printing, photo, radio, cinema, TV, video, multimedia computer systems, Internet) can be divided in two categories: informational and entertaining. Informational media-products influence, basically, on consciousness, intelligence, while entertaining media-products influence on emotion and feelings.

The main objective of consumption by users of media-entertaining products (music, movies, books, games) is receiving the pleasure (positive emotions). This consumption is based on the principle of gaining of the most of pleasure/benefit or, otherwise, an identical level of pleasure at the least level of resistance (i.e. searching of the maximal physical and psychological comfort). For realization of this principle, various methods and systems of definition of user's emotional state and correction of the contents consumed media are invented.

In the U.S. Pat. No. 7,698,238 the system of definition of user's emotional state during consumption of the multimedia contents by him and its changes according to the certain user's emotional state is offered.

In the U.S. Pat. No. 7,610,255 the method and system of definition of emotional code of the user and searching in the network of the multimedia contents appropriate to this code and also people with the similar code is described.

In the application 20100107075 personal “agent”, which constantly traces an emotional state of the user and helps to choose appropriate content to this state, is described.

In the U.S. Pat. No. 7,543,330 the situation, when during communication (computer, phone, online game and etc.) one or both partners have an opportunity to define the emotional state of other subscriber (by voice, from sensors and etc.) and according to it to assume some measures for reception of personal benefit, is described. It is an invasion of privacy and misuse is possible here. For realization of the user's monitoring the captured emotional data, special firewall is offered to use, which forbids the unauthorized access.

In the application 20100205129 it is offered to define the mood of the user and, on the basis of it, to control the network and services.

Deeper understanding of process of media consumption according to the emotional state of the user and designing a system of interaction with media-communication network more adapted to the person is needful.

### SUMMARY

Interaction of the user with global media-communication network is based on a feedback in real time mode and therefore does not include action of the consumer to estimate the current media-product or to change played media-product by another one. The system estimates the emotional state of the user and automatically makes change of media-products.

For remote definition of emotional state, there is a sensor of emotional state of the user, which is combined, for example, with the media-device.

The subsystem of choice of media-products chooses products, which maximize the value of pleasure experienced by user. The choice is carried out from all media-products available at given momentum in the given media-system or in any other media-system. The choice is carried out by optimization of combination of media-products from different categories of media, such as, music, video, text and etc.

At first, the testing of emotional state/mood is carried out, and then media-product is chosen. The choice can be made also considering character of forthcoming occupation of the person. Testing is carried out by presentation to the user a sequence of media-products from the subsystem of storage chosen preferences or by presentation of new media-products. Additionally, for example, the advertising clips of the goods and services can be showed as new media-products.

The subsystem of storage of chosen preferences systematizes and generalizes the preferences of the user and composes his emotional-sensual profile (ESP). Thus, ESP of the user is the key-identifier of an owner, for example, the owner of the personal mobile media-device.

The subsystem of fixing and storage of sharp change of emotional state has the program of testing of the reasons why the person experiences the current emotional state. For example, the media-device detects the person, communication with which was unpleasant, and during next contact the system will warn and offer to accept/refuse to contact.

The subsystem of correction of emotional state has the program of automatic choice of media-products from the subsystem of storage of chosen preferences. Additionally, the subsystem of correction of emotional state has the program-adviser on methods of correction of the current emotional state. Also there is a set of programs for achievement of the given emotional state before the certain moment coming in the current human life, such as, public speech, funeral, congratulation, party, meeting and etc.

The subsystem of searching other users with similar ESP in media-communication network has the program of presentation ESP of the user in automatic search engines. Also there is a program of communication with users having similar ESP and their associating into “virtual villages” on a principle of full emotional-sensual compatibility, the “virtual village” having a set of media-products common for all members. This set of media-products is updated by periodic testing preferences of separate members of the “virtual village”.

The known fact is that the person would like to communicate with the certain people only. The person wants to experience the certain emotions, and the nature has ordered so, that joint experience with other people of identical emotions repeatedly strengthens pleasantly excitant effect. People aspire to do many things together. Together to have fun, eat, to go on football and etc. It is much more interesting to experience pleasant emotions together. It impresses more strongly (behavior on the football, known phenomenon of crowd). That is each person, even unconsciously, aspires to seek the “same feelings person” for joint experience of desired feelings.

Therefore members of “virtual village” have a possibility of simultaneous expression of feelings in virtual space at simultaneous listening/viewing of products, real events and discussions.

However, the user not always has “necessary” mood and emotion, therefore the subsystem of formation/synthesis of the image of the user's face is intended for creation the image under the given emotion for presentation to the current talker by using video communication. In this regard formation/synthesis of the user's face is carried out from former records of face's expressions in ascending order of degree of emotional state.

Hedonistic motives of the human activity are known, according to which activity comply with a principle of “maximization of positive and minimization of negative emotions”, i.e. the activity is directed on achieving a pleasure and enjoyment experiences and avoiding suffering experiences. In this case emotions also are motives of activity. Sometimes they attach deciding importance to emotions; more often emotions are included in number of so-called “motivational variables” side by side with other factors.

However, the interaction with the virtual world, for example, taking delight during entertainment cannot be infinite. The person begins with repeatedly increased energy to aspire to what he did not suffice and to be satiated with that he had in a plenty. It is feeling of satiation. The system should switch the person to other occupations or recommend to rest.

The basic psychical states of the person are known: 1) cheerfulness, 2) euphoria, 3) tiredness, 4) apathy, 5) depression, 6) alienation, 7) loss of feeling of reality. A purpose of media-system will be to transfer psychical state from 3-7 to 1-2. If the psychical state in any way “is not transferred” or “is not transferred any more”, then the state 3-7 should be transferred in rest (sleep, autogenous training or meditation) in order to revive, and only after that to transfer in state 1-2.

Thus, the processes of excitation in brain are periodically changed by processes of braking (rest). Therefore there is a subsystem of definition of the degree of emotional satiation of the user, i.e. coming the phase of braking of brain activity, and then the subsystem switches the user to other kind of activity or rest.

Such system of tracing emotional state has also a subsystem of formation and storage of usual day of the user, which makes records for storage and/or for descendants, which are separate fragments of life, for example, what he ate, with whom communicated, what watched and listened, read and etc.

All people are different; therefore the subsystem of definition and storage of ESP has the program for adaptation of subsystem to psycho-physiological features of the user, which makes definition of the neutral level of emotional state by using physiological parameters of organism and definition of range of parameters of emotional state.

Media-products are created by authors, and they are consumed by users. In exchange for the pleasure received by users (consumers) the author receives a payment. The more influence (pleasure, media effects) on consumers, the higher payment the author should receive. And on the contrary, the less influence (media effects), the lower payment the author should receive.

Aside from authors and consumers there is an intermediary-organizer, who take part in media-process, for example, a label, a television company, a publishing house, provider, a game portal and etc.

Any media-product represents the sum of media constructs (musical phrases, texts, video images and etc.). Different media constructs have a different influence on the consumer. Therefore the user during the consumption of media-product experiences different emotions and feelings. Sometimes the emotional state changes sharply, sometimes slowly. Thus, during perception of media-product the user experiences a various level of emotional state. This level on a time scale can be wavy, peak-shaped and etc.

The emotional state also can be below “zero” (neutral) level, i.e. to pass into state of negative emotions. If to summarize all fluctuations of the user's emotional state during perception by him one of media-products, then it is possible to receive some estimation of this product by the given user.

The estimation of user's emotional state and estimation of media-product have importance for all three participants of media-process (author/artist, consumer and intermediary-organizer).

The system allows for organizing new services, which are not present today in existing networks. For example, members of “virtual village” communicate with authors or media owners without intermediaries, for example, with artists and organize virtual joint consumption of media-product, for example, arrange the concert. Additionally, the consumers of media products pay to the author/owner a fee proportionally to received pleasure. For a realization of such services there is a subsystem of data processing about emotional-sensual features of the “virtual village”.

If to receive estimations of emotional state of the user and an estimation of media-product for some set of products of one of the authors, we shall receive the general estimation of this author by the given user.

If to receive such estimations for some set of authors we shall receive exact representation about the area of preferences of the user in media. It will enable to compose his ESP.

If to trace how the estimation of the user of different authors in various media-systems in the course of time changes, then we shall receive representation of a trajectory of displacement of preferences of the user. It will enable to foresee (predict), which media-products user likes in the greatest degree.

The sum of emotional estimations of the masses of consumers (“virtual village”, concert hall, stadium, region, country, and world) at any moment of time or for some period of time, expressed as some index, is “an index of popularity of the author (artist)”. This index can be determined automatically; in this case it will be objective and will not depend on any manipulations. It also can serve as a basis for giving a prize to the author (similar to former “gold” and “platinum” recording discs), awarding, awarding national (or other) rank, immortalization the name and etc.

Besides, the emotional estimation of consumers can serve as objective basis for the payment for author (artist). Payment should be proportional to the pleasure received by consumers. Therefore payment (or final payment at advance payment) is made after media-product will be perceived by the consumer. Payment can be organized without intermediaries directly between the author and consumers.

The emotional estimation of some experts (fans, professionals) can serve as criterion for selection, correction and development of entry-level author (artist).

The subsystem of data processing about emotional-sensual features of “virtual village” includes items: a) calculation of index of preference of the author (artist); b) calculation of index of preference of the given type of service (kind of show, genre of movie, kind of sports, musical style and etc.); c) the storage of estimations of cost of entertaining services and indexes of preferences of authors, artists, types of entertaining services and etc.; d) composition of the general emotional-sensual profile; e) giving out estimations, indexes and profiles on inquiry of subsystem of forecasting and planning; f) the summator of pleasure of consumers simultaneously consuming entertaining service on each author (artist) and on each type of entertaining services; g) calculation of rating of authors (artist) and entertaining services.

The subsystem for calculation of rating of authors (artist) and entertaining services is based on definition of the general objective parameter using the available data on emotional state of the audience, for example, as product of amount of taking part consumers multiplied by average estimation or index of authors (artists).

Subsystem for calculation of the income of the owner of entertaining service and\or the fee for the author (artist) includes items: a) definitions of the general objective parameter using the available data on emotional state of the audience for entertaining service and/or the given author (artist); b) calculation the income of the owner and/or the fee for the author (artist); c) transfers of the income to the owner and/or the fee into account (or web-purse) of the author (artist).

The organizer of media-process receives an opportunity effectively to control own media-channel, because:
He will know precisely indexes of authors (artists) and dynamics of its change;
He will know precisely a spectrum of preferences of users of his channel;
He continuously can trace the current rating of media channel or media product and analyze their changes with time;
He can plan the activity for the future precisely.

For example, the organization of a system for the content controlling the future media-flow is possible.

Technology of controlling the future content of the media-channel includes:
Composition of ESP of the user using current contents and vital situations;
Sending ESP to the central server in accordance with the consent or without the consent (anonymously) of the user;
Classification of ESP on the server in categories; composition of ESP for a city, region or country.

On the basis of it, the forecasting the future rating of media-product is possible by comparing the ESP of the scenario (content) and the appropriate categories on the central server. Objective choice of the director of the future movie by results of comparison of his ESP with required one for the movie.

Work of “Automatic Hollywood” can be as follows:
The rating of the future movie (for example, 80 million of spectators) is given;
Sorting of ESP by using database of spectators is carried out so that the sum of the chosen cells will equal to the given number;
ESP of future film is composed;
The scenario is written;
The director, actors is chosen;
And etc.

Process of choice of the author (actor) by the user is accidental today. Such a fact frequently creates a phenomenon of false (dying away) “stars”. Process of appearance of false “stars” has cumulative character because it is composed using preferences of masses of users, which, not having objective estimations, first time choosing the authors (artists) most popular at present. Therefore popularity of such author (artist) can remain long time high (or even grow) in spite of the fact that there can be more talented author (artist) near to him.

The subsystem of forecasting and planning cost of the future entertaining services (works, products) includes items: a) inquiry of consumers and gathering estimations, indexes and profiles; b) qualifier of ESP of consumers (based on psychological types of persons; cities, regions, countries and etc.; age, professional, confessional, sexual and other attributes; by kinds of entertaining services and etc.); c) storage of ratings of authors (artists) and entertaining services; d) storage of expert psychological estimations and emotional-sensual profiles of scenarios (contents) of the future entertaining services (works, products); e) the storage of emotional-sensual profiles of direct participants of process of realization of entertaining service, i.e. people rendering direct influence on character of perception of service (product, a product) by the consumer, such as, the director, the artist, executor, sportsman, a type in game and etc.; f) comparisons ESP of the declared scenarios with appropriate cells of the classifier and definition of the future rating of media-product; g) comparisons of the declared rating with cells of classifier by choice of the cells appropriate to rating with the necessary sum of consumers and composition, using them, ESP of the future scenario (contents) of service (work, product).

The subsystem of offering new services (works, products) to the consumer includes items: a) inquiry of consumers in order to gather estimations, indexes and profiles; b) the storage of new services (works, products) with their ESP; c) choice of services (works, products) appropriate to the given consumer; d) offers to the consumer of new services (works, products) with emotional feedback for the reception of their estimation; e) storage of preferences and refusals on each consumer.

The subsystem “the direct media-channel between the artist and consumer in real time mode” includes items: a) gathering applications of consumers on performance of those or other media-products; b) composition of timetable of media-concert with the indication of its key parameters, for example, time of the beginning and termination, sequence of performance, content as names of media-products; c) account of wishes of consumers and the artist on the timetable content; d) account of psychological features of audience; e) account (or web-purse) of the artist; f) making a purse from audience, for example, by preliminary “freezing” some stipulated before amount of money on the account of the consumer, “defreezing” of which and final payment is made after the termination of media-concert in view of value of the pleasure received by the consumer; g) settlement and payment of cost of services of the media-organizer, for example, provider; h) Processing the current emotional state of consumers and giving out to the artist of the total diagram of emotional state of audience change, including various attributes of approval or disapproval by audience of the current performance, for example, “applause”, “encore!”, “bravo!”, “bouquets of flowers”, “whistle”, “stamping by legs”, “rotten eggs” and etc.; i) Changes of the content of timetable by the artist depending on the current emotional state of the audience; j) Changes of the scenario in real time mode with giving out the changes to the artist by the way, which is imperceptible for audience, for example, by using headphones, video-projectors, prompters, switching on beforehand prepared identical artist (real or virtual), using the records previously made and etc.

In case of realization of concert (any media-entertaining action) in conditions of real hall (stadium and etc.) the action can be organized as follows.

The concert is specific service on creation of the pleasure to the spectator. The pleasure is the sum of positive emotions experienced by the person during the concert. Organizers of concert make a proposal for potential buyers of this specific service by advertising and announcements to buy it. In this regard the price of the ticket usually depends on the place of spectator in the hall, on convenience of seats, on quality of transmitted sound and etc. Such prices are fixed and do not depend in any way on value and quality of the service received by the spectator. Organizers of concert make fixed price of tickets arbitrarily, being guided on certain “average spectator”.

But each person is individual, his psychological state is changeable; behavior (creative mood) of artist on a stage is predicted difficultly. All this facts makes absolutely impossible an exact definition of value and quality of rendered specific service anticipatorily. Such value and quality can be defined only at the end of concert, as sum of the pleasure received by the spectator. Existing methods of definition (for example, individual inquiry of spectators on the exit after concert) are biased, take away a lot of time and do not solve the problem of exact correlation of the ticket price and quality of the received service.

Any collective or individual actions, the goal of which is to deliver pleasure to participants, can be considered as entertainment.

Information about the pleasure received by participants can be used for other purposes: for example, for definition of winners in contests, festivals, competitions etc.

During all paid public action the measure of emotional state of participants is carried out and the general and individual level on various parameters is calculated: average level, value of peak, duration of peak, quantity of peaks and etc.

Definition of ESP, tracing video clips viewed in given moment, and the linguistic analysis of the current conversation of the user allow revealing and predicting the nearest, but still unconscious needs of the user.

This fact is explained by the following.

The human is the biochemical machine, in which there are physiological and nervous processes. If processes are balanced and there is no deficit of resources (feeding these processes), then there is no imbalance, there is no present displacement of processes in the negative side, and there is no need to result processes to a condition of dynamic balance. As soon as imbalance of something comes (deficit), the negative parameter starts to increase and nervous receptors start to catch this increase.

The signal grows, exceeds noise level and is caught (fixed) by a subcortex and it is the first threshold of sensitivity. The subcortex has influence on a cortex, but mediated, not obvious, not direct. Some weak, indistinct signal moves into cortex. This signal causes unconscious feeling of alarm and anxiety. The signal grows further and reaches a threshold of awareness (the second threshold of sensitivity) when the need is formulated as precise requirement in the verbal form. Only after this the person realizes, what it is necessary to him, and achieves satisfaction of need.

Till now all nonmaterial and trade tried to influence on brain, which has realized own needs. Here all solutions have been found already and the further development is impossible. The next step of development is a zone between the first and second threshold of sensitivity, because the signal, which not reached the level of the first threshold of sensitivity, is found in a noise zone and it basically is not distinguished. The solution of problem of tracing of need between the first and second threshold of sensitivity consists of the following. The special program in computer traces all preferences of the person, such as, what he writes and watches, force of pressing keys, timbre of voice, emotional state, mimicry and etc. These data are transmitted to be analyzed into expert system where they are compared to psycho-physiological manifestations (parameters) received earlier during testing the user. On an output the most probable need, which will be realized by the user in the near future, is formulated.

The subsystem of revealing and forecasting the nearest needs of the user includes items: a) fixing current ESP; b) fixing physical state, for example, user lies, sits, goes and etc.; c) fixings time of the day; d) fixings kind and character of consumed media content; e) fixing characteristic words said; f) analysis of previous items and comparison of the results with the typical manifestations of the user in life recorded earlier; g) giving of signal to the user about requirement coming soon.

System also has a subsystem of control of the speed and content of transmitted media-product.

Different people perceive all differently, with different speed of perception and understanding. The person has desire to watch movie up to the end, but frequently person does not like movie (but it would be desirable to learn the end of story). It is necessary to reduce time of watching movie. Or on the contrary, if the person likes movie, then to stretch the pleasure. Depending on interest of the spectator, the same episode can be shown unwrapped or compressed based on emotional feedback. Methods of change of speed depending on emotional state include:
Transmission one of several variants of movie recorded before;
Cutting or addition of the frames.

The same is with music: removal of emotionally failed pieces of the text and music, change of arrangement, structure of tools and etc.

The subsystem of control of the speed and content of transmitted media-product includes items: a) fixing current ESP; b) cutting out superfluous media constructs; c) library of inserted media constructs; d) insertion of additional media constructs; e) manual control of cutting out operations, insertion and repetition of media constructs.

People with similar ESP can be called as “same feelings people” (as analogy with “the same thinking people”).

The same feelings persons form a “virtual village”. Such villages will be dynamical since the emotional preferences are changing; villages will be appear and disappear, flow into other formations.

The same feeling persons are people with close biosocial instincts. At rough gradation there is no more than 30 variations (in accordance with socionics, there are 32 types of people). Taking into account excellent tastes of especially advanced persons, there can be, probably, some thousands of such types. However, there are billions people on the Earth. That means, with an easy opportunity to detect “same feeling person” in the virtual world, many thousands symbioses will be created on the basis of full emotional compatibility.

Appearance of these symbioses will be similar to association of unicellular organisms into multicellular one. The primitive network of “monocelled” sites of today's internet will turn into more complex organism from automatically created “virtual villages” of the same feeling people.

What is the benefit here for the users? Any organized system is steadier, is viable, adapts to changes of external conditions more easy.

Let us list the basic benefits for the user:

a) The uniform adapted market of workplaces and labor force;

b) Uniform constantly updated playlist of media-entertainments for all participants;

c) The effect of repeated strengthening of joint perception works;

d) There is an opportunity of full self-realization of the person;

The explanatory for the id item are. The biosocial complex (instinct) of the human is formed from combination of various qualities and properties (caused genetically and acquired during education); this complex is one for all life (life brings only small corrections). The main aspiration of the human during his life is self-realization, i.e. desire to follow to biosocial instinct given by nature. If the person has realized self-realization, then he feels like happy. With the help of “virtual village” the person will be occupied with such activity, which will allow him to realize the innate biosocial needs and own social instinct.

e) An integrated information flow is completely adapted to the given category; that means the information is completely acquired.

The explanatory for e item are as follows. From the early childhood and during all life, the person perceives only a part of information. That part, which helps him to reach self-realization, makes very strong and pleasant impression on the person and is well remembered. That part of the information, which is useless or harmful from the point of view of self-realization, is not noticed by the person and not remembered. The person is simply fenced off the unnecessary and inconvenient information. Psychologists discovered a set of principles, with which help the person fenced off the inconvenient and unpleasant information. Such principals are, for example, denying, displacement, projection, identification, rationalization, replacement etc. Thus the person can protect himself both consciously and unconsciously. Thus, from the early childhood the person as sponge absorbs in himself the information, but only that part, which helps him to reach self-realization. In the “virtual village” there will be only such information.

f) Search of the partner for creation of family by the principle of full emotional compatibility (in the “my” village) or by the complementarity principle (in an “alien” village) is facilitated;

g) The problem of a suicide disappears because it will be enough for the self-murderer to get in the village, where he will be understood, and inhabitants will help him at the same time;

h) Only the “same feeling people”, thoroughly knowing features of own character, can create any financial structures with the highest degree confidentiality and securities.

The world will divide on spheres by emotional properties: each sphere has own style, games, habits, entertainments, universities, brand of cars and etc.

In the real world the people will be mixed, but in virtual world everyone will be in his own village.

Further it will be possible to test not only emotional state, but also intellectual, physical and etc. There will be a stratification of mankind by groups, layers and societies.

Let's consider other possible applications of system.

Let's imagine a school lesson with ESP definition. The teacher tells teaching material of the lesson using the thought over plan. It is always a mix of the information, rules, examples and conclusions. By way of lesson the purpose of lesson is determined: pupils should acquire some main thing. To acquire means to understand and remember. The person remembers it well only if, at present, it is emotionally painted, positively or negatively. The lesson is created in such manner that the information-explanation (i.e. logic perception) is carried out in emotionally neutral state of pupils, but storing is carried out in emotionally painted state. Such state is created by special psychological receptions, for example, in course of the story telling about rules of self-defense from an attack of hooligans, materials of a real criminal case are shown along with analysis of mistakes of the victim, with showing of consequences and etc., and, at the moment of the greatest peak of negative ESP (pupils experiences a horror); the teacher tell them a short capacious rule of behavior that it never happen to pupils. For creating necessary ESP the teacher, for example, refers (shows a video record) to the statement of the person most popular and reputable among pupils (such as a singer, sportsman, hero of a cartoon and etc.).

It is important to define ESP of employees, to create a collective so, that there was no incompatibility and disputed situations. It is applicable also to sportsmen, military, rescuers, physicians and etc. That is the system can become an automatic manager on the personnel (or his assistant). It is possible to trace how the person perceives any pictures on a wall (test pictures), musical or video fragments (unostentatiously appearing), including a case of real work, meeting with the director and etc.

In the airplane the person can listen to the music, which is pleasant only for him.

There could be a personal guide on ESP basis to take into account interests of each visitor and to transmit more detailed or less detailed story in a museum, at an exhibition and etc.

An automatic adviser in shop takes into account ESP of the buyer and offers to buy the goods at the moment of peak of his emotional state. Or he can include recommendations of emotionally significant person for the user (for example friend, relatives, outstanding persons and etc.). If the emotional condition goes down, then the advisor offers discounts on the price right away.

The family is the special union of the “same feeling people”. Frequently there is a desire to connect to joint sensation (for example, sometimes to watch for the reaction of a child on new animated cartoon is much more interesting than to watch movie itself).

When politician speaks at meeting and tries to trace mood of crowd then he does not have means to influence on people, except for his speech. He should, as it has always been, to speak and convince. Appearance of a new element (ESP sensor of crowd) will allow tracing total mood of crowd and to correlate it to phrases of the orator, giving him a signal and advice.

Exact detecting emotional state of the user is possible only by means of the appropriate hardware. VibraImage technology is most appropriate for the purposes of the given disclosure.

This technology is based on V. A. Minkin's opening of a new phenomenon in the human psychophysiology: full interrelation of psychoemotional state with micromovings of the center of gravity of the person, in particular, of head. Micromovements of points of the person's face are continuously traced by videocamera (built in any technical device, external and etc.) and is analyzed with the help of a program. The program defines the psychoemotional state of the person at each given moment of time.

Vibroimage for psychology is similar to the invention of microscope for biology. At a level of micromovements the new world of emotions opens which can be defined automatically with the help of technical facilities. Vibroimage is a nanopsyhology, in which displacement of the center of gravity of the person in the balance condition by some nanometers reflects manifestation of consciousness and subconsciousness.

The technical task of defining user's psychophysiological state is related to biometrics. Biometrics unites physics, mathematics, medicine and psychology for measurement of biological and/or behavioral characteristics of the person with the purpose of identification of the person's psychophysiological state.

On the basis of this opening, the system of remote contactless scanning and identification of the person's psychophysiological state is created.

Vital activity of the human or any living object is associated with a set of periodic processes (breath, pulse, work of sensitive systems), taking place in organism. Intensity of physiological processes is associated to organism's state. When the person is calm and having a rest, frequency of cardiac beat is minimal. When the person is excited, heart rate rises and breathing becomes frequent. Frequency of vibrations of the person reflects energetics of his movement that means mental condition, emotions and health also.

For the characteristic of vibroimage, four functionally independent groups of the parameters were chosen, which describe various properties such as amplitude, frequency, symmetry and vibroimage processing.

Efficiency of psychophysiological state definition was confirmed with comparative tests and measurement of parameters by known methods (EEG—electroencephalogram, GSR—galvanic skin response, ECG—electrocardiogram) and psychological tests (Buss-Durkey inventory, Hend's test, Lusher's test).

The program is provided with a function of definition of neutral (“zero”) emotional state. Such definition takes (default) 10 seconds.

The vibroimage technology allows controlling user's state in real time mode, i.e. to fix change of vibroimage in the same split second when the state of the person has changed. It can be defined with the help of “fast” parameters of vibroimage, for example, the parameters determined by difference of two near frames. Thus, certainly, it is necessary to take into account a possibility of influence of casual errors in the received result. The increase of time of accumulation of difference between two near frames allows increasing accuracy and reliability of measurements, but complicates fixing fast flowing processes. Results of researches of human vibroimage have shown that the time of accumulation, which is equals to about 10 seconds, is optimal for definition of the person's state with the help of vibroimage technology.

On the screen of his monitor the user of system can watch the image, vibroimage and aura of objects to make record and process vibroimage parameters, define the emotional state of the person and state of health.

System of vibroimage makes automatic monitoring the level of emotions, and also carries out lie detection in real time mode.

System of vibroimage allows to analyze the videofiles (.avi) recorded previously and to carry out the emotional control of the person in the video materials received from any source.

System of vibroimage analyzes and registers more than 20 parameters of vibroimage and offers to the user to carry out the adjustment of system according to his aims and define required psychophysiological parameters of the person.

Program of videoimage includes three independent program modules: program for working with living video (VibraImage), program for viewing recorded videos and log files (LogViewer), program for viewing and printing the archive of recorded vibroimages of patients (VIPrinter).

Program VibraImage allows each user having computer and web camera to carry out his personal or scientific psychophysiological researches.

The researcher working with the system receives a unique opportunity of objective control of psychophysiological state of himself, relatives or patients with the help of standard hardware.

### BRIEF DESCRIPTION OF THE DRAWINGS

The foregoing and other purposes, features, and profits of the disclosure will be apparent from the following more particular description of submitted embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows the structure of system of interaction between users and global media-communication network.

FIG. 2 shows the structure of “virtual village”.

FIG. 3 shows the structure of subsystem of data processing about emotional-sensual features of “virtual village”.

FIG. 4 shows the structure of subsystem for calculation of the income of the owner of entertaining service and/or fee for the author (artist).

FIG. 5 shows the structure of subsystem of forecasting and planning cost of the future entertaining services (works, products).

FIG. 6 shows the structure of subsystem of new services (works, products) offer for the consumer.

FIG. 7 shows the structure of subsystem “the direct media-channel the artist—the consumer in real time mode”.

FIG. 8 shows the structure of subsystem of revealing and forecasting the nearest needs of the user.

FIG. 9 shows the structure of subsystem of control of speed and content of transmitted media product.

### DETAILED DESCRIPTION

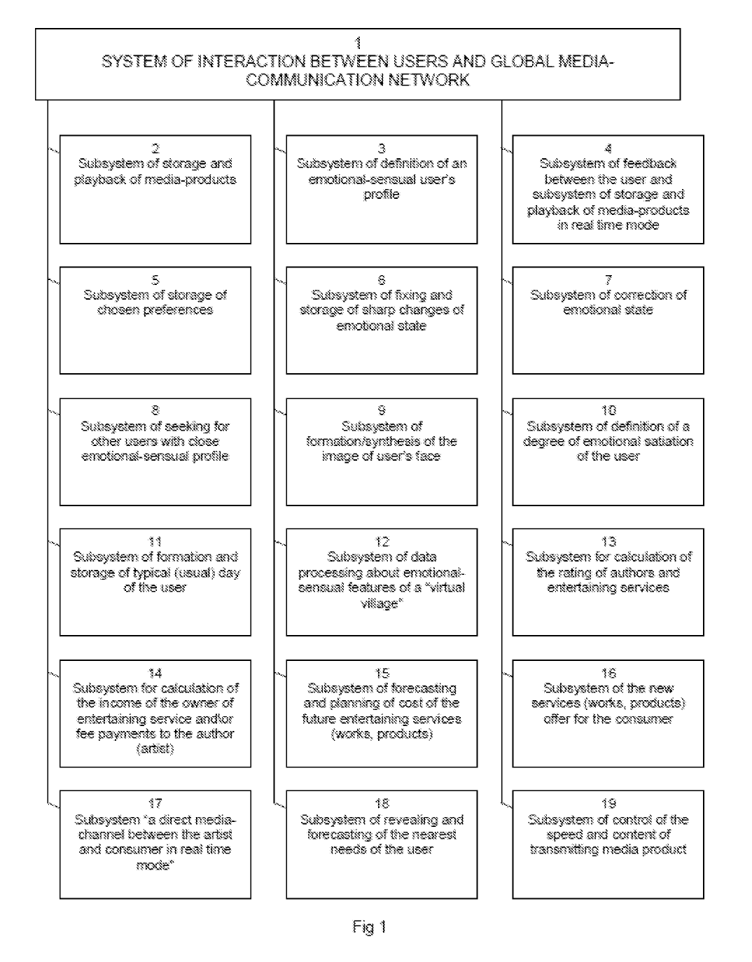

FIG. 1 shows the structure of system of interaction between users and global media-communication network. System 1 of interaction between users and global media-communication network includes: subsystem 2 of storage and playback of media-products, subsystem 3 of definition of emotional-sensual user's profile, subsystem 4 of feedback between the user and subsystem of storage and playback of media-products in real time mode, subsystem 5 of storage of chosen preferences, subsystem 6 of fixing and storage of sharp changes of emotional state, subsystem 7 of correction of emotional state, subsystem 8 of seeking for other users with close emotional-sensual profile, subsystem 9 of formation/synthesis of the image of user's face, subsystem 10 of definition of a degree of emotional satiation of the user, subsystem 11 of formation and storage of typical (usual) day of the user, subsystem 12 of data processing about emotional-sensual features of a “virtual village”, subsystem 13 for calculation of the rating of authors and entertaining services, subsystem 14 for calculation of the income of the owner of entertaining service and/or fee payments to the author (artist), subsystem 15 of forecasting and planning cost of the future entertaining services (works, products), subsystem 16 of the new services (works, products) offer to the consumer, subsystem 17 “a direct media-channel between the artist and consumer in real time mode”, subsystem 18 of revealing and forecasting the nearest needs of the user, subsystem 19 of control of the speed and content of transmitting media product.

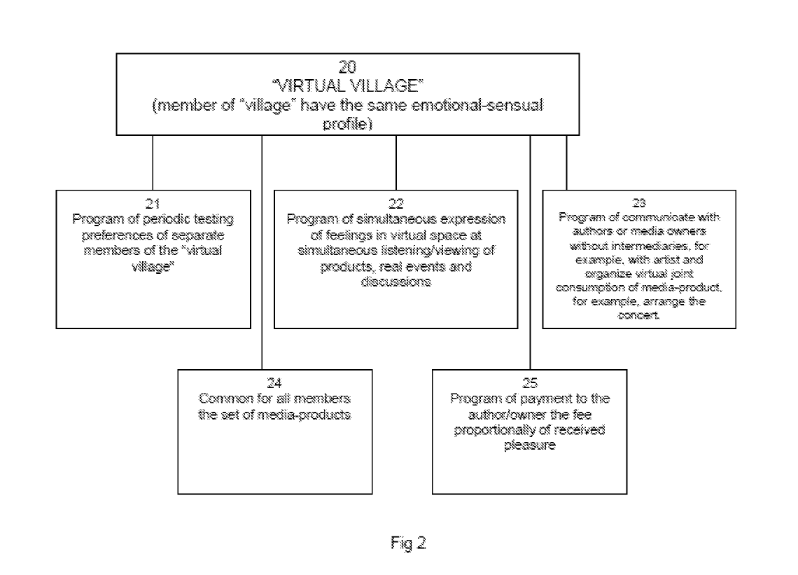

FIG. 2 shows the structure of “virtual village”. “Virtual village” 20 includes: program 21 of periodic testing preferences of separate members of the “virtual village”, program 22 of simultaneous expression of feelings in virtual space during simultaneous listening/viewing of products, real events and discussions, program 23 of communication with authors or media owners without intermediaries, for example, with artist and setting up virtual joint consumption of media-product, for example, arrange the concert, common for all members set 24 of media products, program 25 of payment to the author/owner the fee proportionally of received pleasure.

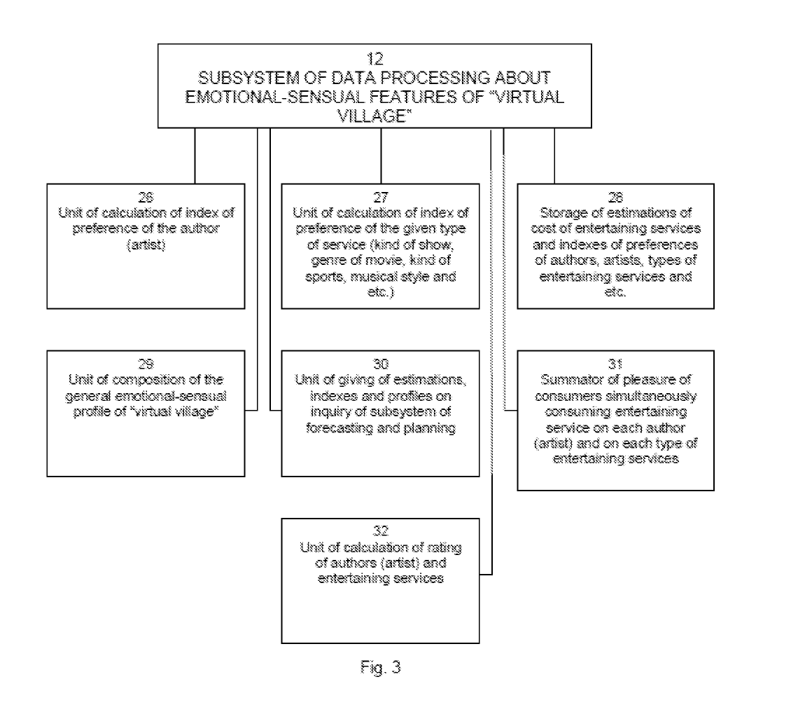

FIG. 3 shows the structure of subsystem of data processing about emotional-sensual features of “virtual village”. The subsystem 12 of data processing about emotional-sensual features of “virtual village” includes: unit 26 of calculation of index of preference of the author (artist), unit 27 of calculation of index of preference of the given type of service (kind of show, genre of movie, kind of sports, musical style and etc.), storage 28 of estimations of cost of entertaining services and indexes of preferences of authors, artists, types of entertaining services and etc., unit 29 of composition of the general emotional-sensual profile, unit 30 of giving out estimations, indexes and profiles on inquiry of subsystem of forecasting and planning, summator 31 of pleasure of consumers simultaneously consuming entertaining service on each author (artist) and on each type of entertaining services, unit 32 of calculation of rating of authors (artist) and entertaining services.

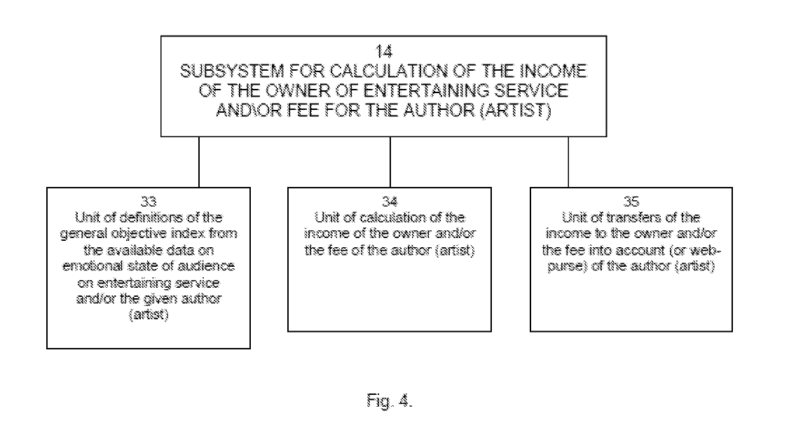

FIG. 4 shows the structure of subsystem for calculation of the income of the owner of entertaining service and/or fee for the author (artist). Subsystem 14 for calculation of the income of the owner of entertaining service and/or fee for the author (artist) includes: unit 33 of definitions of the general objective index from the available data on emotional state of audience on entertaining service and/or the given author (artist), unit 34 of calculation of the income of the owner and/or the fee of the author (artist), unit 35 of transfers of the income to the owner and/or the fee into account (or web-purse) of the author (artist).

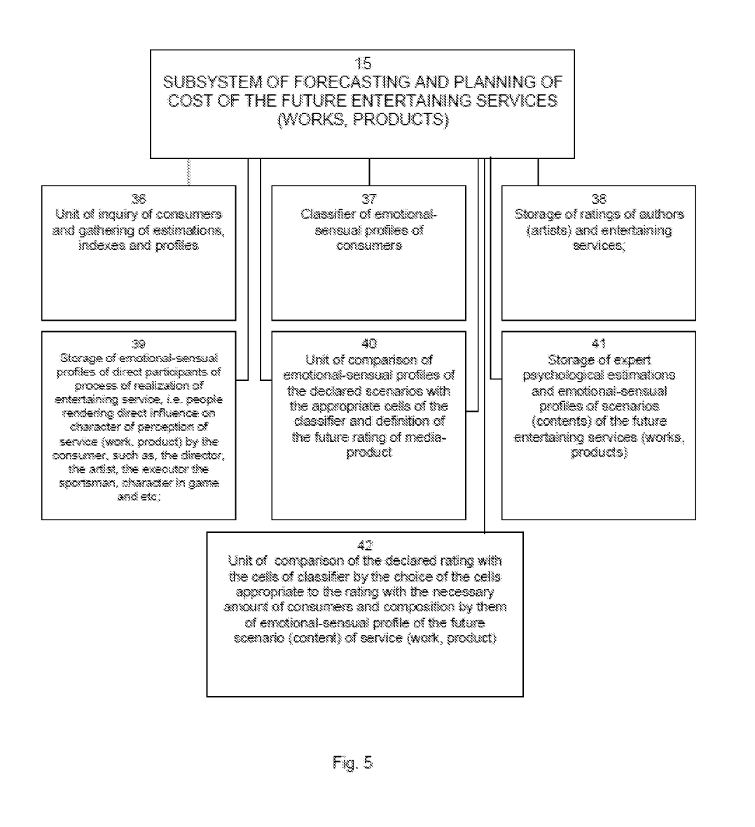

FIG. 5 shows the structure of subsystem of forecasting and planning the cost of the future entertaining services (works, products). Subsystem 15 of forecasting and planning the cost of the future entertaining services (works, products) includes: unit 36 of inquiry of consumers and gathering of estimations, indexes and profiles, classifier 37 of emotional-sensual profiles of consumers (on psychological types of persons; on cities, regions, countries and etc.; on age, professional, confessional, sexual and other attributes; by kinds of entertaining services and etc.), storage 38 of ratings of authors (artists) and entertaining services, storage 39 of emotional-sensual profiles of direct participants of process of realization of entertaining service, i.e. people rendering direct influence on character of perception of service (work, product) by the consumer, such as, the director, the artist, the executor the sportsman, character in game and etc., unit 40 of comparison of emotional-sensual profiles of the declared scenarios with the appropriate cells of the classifier and definition of the future rating of media-product, storage 41 of expert psychological estimations and emotional-sensual profiles of scenarios (contents) of the future entertaining services (works, products), unit 42 of comparison of the declared rating with the cells of classifier by the choice of the cells appropriate to the rating with the necessary amount of consumers and composition by them of emotional-sensual profile of the future scenario (content) of service (work, product).

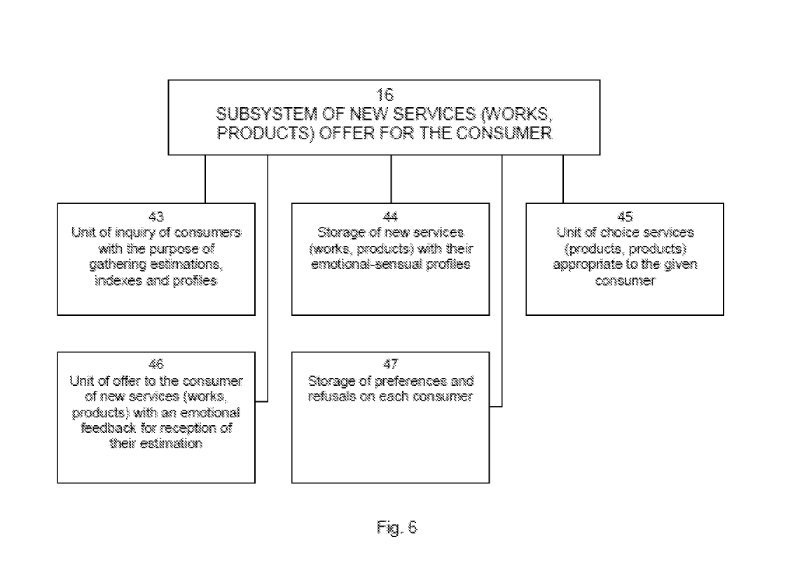

FIG. 6 shows the structure of subsystem of new services (works, products) offer for the consumer. The subsystem 16 of new services (works, products) offer for the consumer includes: unit 43 of inquiry of consumers with the purpose of gathering estimations, indexes and profiles, storage 44 of new services (works, products) with their emotional-sensual profiles, unit 45 of choice of services (products, products) appropriate to the given consumer, unit 46 of offer to the consumer of new services (works, products) with an emotional feedback for reception of their estimation, storage 47 of preferences and refusals on each consumer.

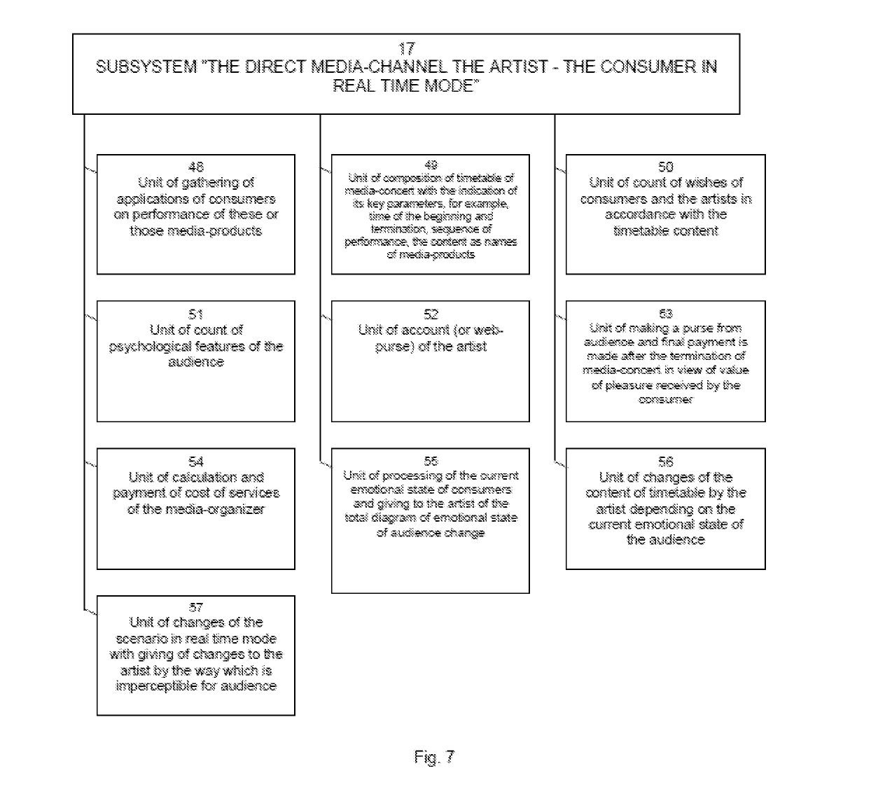

FIG. 7 shows the structure of subsystem “the direct media-channel the artist—the consumer in real time mode”. Subsystem 17 “the direct media-channel the artist—the consumer in real time mode” includes: unit 48 of gathering applications of consumers on performance of these or those media-products, unit 49 of composition of timetable of media-concert with the indication of its key parameters, for example, time of the beginning and termination, sequence of performance, the content as names of media-products, unit 50 of count of wishes of consumers and the artists in accordance with the timetable content, unit 51 of count of psychological features of the audience, unit 52 of account (or web-purse) of the artist, unit 53 of making a purse from audience, for example, by preliminary “freezing” of some stipulated amount of money on the account of the consumer before, which “defreezing” and final payment is made after the termination of media-concert in view of value of pleasure received by the consumer, unit 54 of calculation and payment of cost of services of the media-organizer, for example, a provider, unit 55 of processing the current emotional state of consumers and giving out to the artist of the total diagram of emotional state of audience change, including various attributes of approval or disapproval by audience of the current performance, for example, “applause”, “encore!”, “bravo!”, “bouquets of flowers”, “whistle”, “stamping by legs”, “rotten eggs” and etc., unit 56 of changes of the content of timetable by the artist depending on the current emotional state of the audience, unit 57 of changes of the scenario in real time mode with giving out the changes to the artist by the way, which is imperceptible for audience, for example, by using headphones, video-projectors, prompters, switching on beforehand prepared identical artist (real or virtual), using the records previously made and etc.

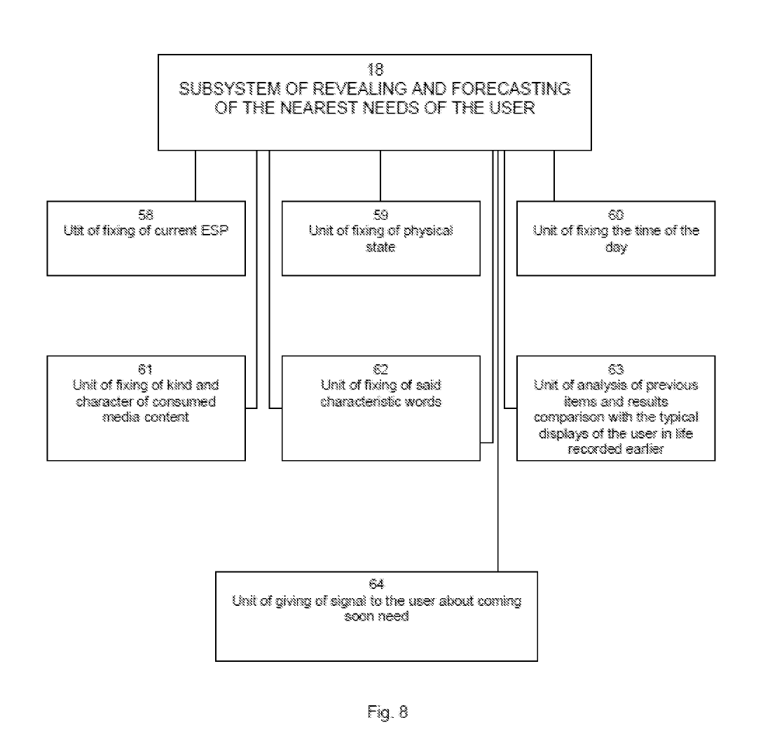

FIG. 8 shows the structure of subsystem of revealing and forecasting of the nearest needs of the user. Subsystem 18 of revealing and forecasting the nearest needs of the user includes: unit 58 of fixing current ESP, unit 59 of fixing physical state, for example, user lies, sits, goes and etc., unit 60 of fixing the time of the day, unit 61 of fixing of kind and character of consumed media content, unit 62 of fixing of said characteristic words, unit 63 of analysis of previous items 58-62 and results comparison with the typical manifestations of the user in life recorded earlier, unit 64 of giving a signal to the user about coming soon need.

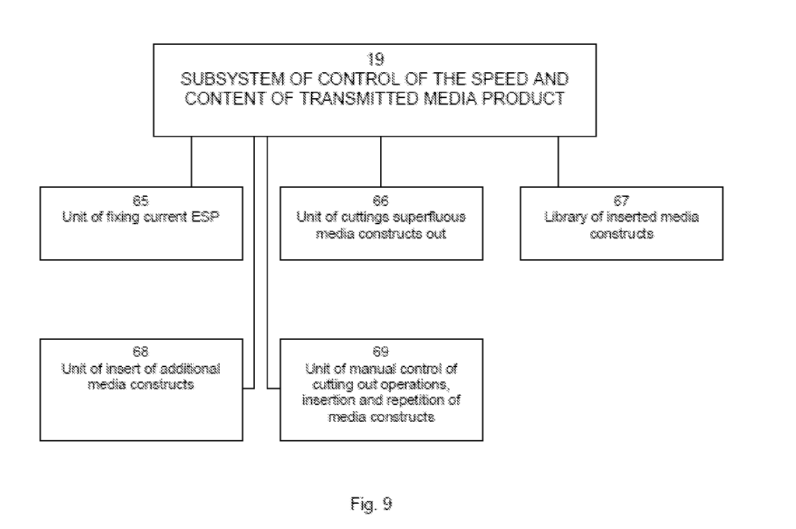

FIG. 9 shows the structure of subsystem of control of speed and content of transmitted media product. Subsystem 19 of control of speed and content of transmitted media product includes: unit 65 of fixing current ESP, unit 66 of cuttings superfluous media constructs out, library 67 of inserted media constructs, unit 68 of insert of additional media constructs, unit 69 of manual control of cutting out operations, insertion and repetition of media constructs.

What is claimed is:

1. A system of communication between users and global media-communication network, the system comprising:
a subsystem of storage and playback of media-products;
a subsystem of definition of an emotional-sensual user's profile;
a subsystem of a feedback between the user and a subsystem of storage and playback of media-products in real time mode;
a subsystem of storage of chosen preferences;
a subsystem of fixing and storage of sharp changes of emotional state;
a subsystem of correction of emotional state;
a subsystem of seeking for other users with close emotional-sensual profile;
a subsystem of formation of the image of user's face;
a subsystem of definition of a degree of emotional satiation of the user;
a subsystem of formation and storage of typical (usual) day of the user;
a subsystem of data processing about emotional-sensual features of a virtual village;
a subsystem for calculation of a rating of authors and entertaining services;
a subsystem for calculation of the income of the owner of entertaining service and fee payments to the author (artist);
a subsystem of forecasting and planning of cost of the future entertaining services (works, products);
a subsystem of the new services (works, products) offer for the consumer;
a subsystem a direct media-channel between the artist and consumer in real time mode;
a subsystem of revealing and forecasting of the nearest needs of the user; and
a subsystem of control of the speed and content of transmitting media product.

2. The system of claim 1, wherein the feedback in real time mode does not include explicit action of the consumer on estimation of the current media-product or on change of playing media-product by another one.

3. The system of claim 1, wherein the subsystem of feedback includes the sensor of emotional state of the user.

4. The system of claim 3, wherein the sensor of emotional state is a part of a media-device.

5. The system of claim 1, wherein the subsystem of choosing of media-products chooses products, which maximize a value of pleasures experienced by the user.

6. The system of claim 5, wherein the choice is realized from all media-products available at present time in the given media-system.

7. The system of claim 5, wherein the choice is realized from all media-products available at present time in any other media-system.

8. The system of claim 5, wherein the choice is realized by optimization of combination of media-products from different media categories, such as, music, video, text and etc.

9. The system of claim 5, wherein the choice is realized by testing and in view of character of forthcoming occupation of the person.

10. The system of claim 5, wherein the testing of emotional state firstly is carried out and then media-product is chosen.

11. The system of claim 10, wherein the testing is carried out by presentation to the user of a sequence of media-products using a subsystem of storage of chosen preferences.

12. The system of claim 10, wherein the testing is carried out by presentation to the user of new media-products.

13. The system of claim 10, wherein the advertising clips of the goods and services as new media-products are presented.

14. The system of claim 1, wherein the subsystem of storage of chosen preferences systematizes and generalizes preferences of the user and makes his emotional-sensual profile (ESP).

15. The system of claim 14, wherein ESP of the user is a key-identifier of the owner of personal mobile media-device.

16. The system of claim 1, wherein the subsystem of fixing and storage of sharp change of emotional state has the program of testing of causes, on which the person experiences the current emotional state.

17. The system of claim 16, wherein the media-device defines the person, communication with which was unpleasant.

18. The system of claim 17, wherein at the following contact the system warns and offers to approve/refuse to contact.

19. The system of claim 1, wherein the subsystem of correction of emotional state has the program of an automatic choice of media-products using subsystem of storage of chosen preferences.

20. The system of claim 19, wherein the subsystem of correction of emotional state has the program-adviser for methods of correction of current emotional state.

21. The system of claim 19, wherein there is a set of programs for achievement of the given emotional state before an occurrence of the certain moment in the current person's life, such as, a public speech, a congratulation, a party, appointment and etc.

22. The system of claim 1, wherein the subsystem of seek for other users with similar ESP in a media-communication network has the program of presentation of user's ESP for automatic search engines.

23. The system of claim 22, wherein the subsystem of seeking for users with similar ESP in media-communication network has the program of communication with users having similar ESP and their associations in virtual villages by a principle of full emotional-sensual compatibility.

24. The system of claim 23, wherein the virtual village has the set of media-products, which are common for all members.

25. The system of claim 23, wherein the set of media-products is updated by periodic testing of preferences of separate members of virtual village.

26. The system of claim 23, wherein members of virtual village have an opportunity of simultaneous expression of own feelings in virtual space at simultaneous listening/viewing of products, real events or discussions.

27. The system of claim 1, wherein the subsystem of formation of the image of the user's face is intended for formation of the image under the given emotion for presentation to the current interlocutor using video-communication.

28. The system of claim 27, wherein formation of the face's image is carried out of former recordings of face's expressions disposed in the ascending sort of degree of emotional state.

29. The system of claim 27, wherein the subsystems of definition of degree of emotional satiation of the user i.e. approach of inhibitory phase of brain activity, switches the user to other kind of activity or rest.

30. The system of claim 1, wherein the subsystem of formation and storage of typical (usual) day of the user records separate fragments of life for the person's purposes and for descendants, for example, what the food the user ate, with whom he communicated, what watched and listened and read.

31. The system of claim 14, wherein there is a program for adaptation of subsystem of definition of emotional state to psycho-physiological features of the user, which defines a neutral level of emotional state on physiological parameters of organism and definition of range of parameters of emotional state.

32. The system of claim 23, wherein the members of “virtual village” communicate without intermediaries to authors or owners of media content, for example, artists and organize virtual joint consumption of media-product, for example, arrange a concert.

33. The system of claim 23, wherein the consumers of media content pay to the author a fee proportionally of received pleasure.

34. The system of claim 1, wherein the subsystem of data processing about emotional-sensual features of virtual village includes items:
a calculation of an index of preference of the author (artist);
a calculation of an index of preference of the given type of service;
a storage of estimations of costs of entertaining services and indexes of preferences of authors, artists, types of entertaining services;
composing a general emotional-sensual profile;
giving out estimations, indexes and profiles on inquiry of subsystem of forecasting and planning;
a summator of pleasure of consumers simultaneously consuming entertaining service on each author (artist) and on each type of entertaining services; and
a calculation of rating of authors (artist) and entertaining services.

35. The system of claim 1, wherein the subsystem for calculation of a rating of authors (artists) and entertaining services is based on definition of the general objective index from the available data on emotional state of audience, for example, as product of quantity of taking part consumers multiplied by an average estimation or index of authors (artists).

36. The system of claim 1, wherein the subsystem for calculation of the income of the owner of entertaining service and the fee for the author (artist) includes:
definitions of the general objective index from the available data on emotional state of audience on entertaining service and the given author (artist);
a calculation of the income of the owner and the fee of the author (artist); and
transfers of the income to the owner and the fee into account (or web-purse) of the author (artist).

37. The system of claim 1, wherein the subsystem of forecasting and planning of cost of the future entertaining services (works, products) includes items:
an inquiry of consumers and gathering estimations, indexes and profiles;
an classifier of emotional-sensual profiles of consumers;
a storage of ratings of authors (artists) and entertaining services;
a storage of expert psychological estimations and emotional-sensual profiles of scenarios (content) of the future entertaining services (works, products);
a storage of emotional-sensual profiles of direct participants of process of realization of entertaining service, i.e. people rendering direct influence on character of perception of service (work, product) by the consumer, such as, the director, the artist, the executor the sportsman, character in game;
a comparison of emotional-sensual profiles of the declared scenarios with the appropriate cells of the classifier and definition of the future rating of media-product; and
a comparison of the declared rating with the cells of classifier by the choice of the cells appropriate to the rating with the necessary amount of consumers and composition by them of emotional-sensual profile of the future scenario (content) of service (work, product).

38. The system of claim 1, wherein the subsystem of the offer of new services (works, products) to the consumer includes items:
an inquiry of consumers with the purpose of gathering estimations, indexes and profiles;
a storage of new services (works, products) with their emotional-sensual profiles;
choice services (products, products) appropriate to the given consumer;
an offer to the consumer of new services (works, products) with an emotional feedback for reception of their estimation; and
a storage of preferences and refusals on each consumer.

39. The system of claim 1, wherein a subsystem “the direct media-channel between the artist and the consumer in real time” includes items:
gathering applications of consumers on performance of these or those media-products;
an composition of timetable of media-concert with the indication of its key parameters, for example, time of the beginning and termination, a sequence of performance, the content as names of media-products;
an count of wishes of consumers and the artists in accordance with the timetable content;
an count of psychological features of the audience;
an account (or web-purse) of the artist;
making a purse from audience, for example, by preliminary freezing of some stipulated sum on the account of the consumer before, which “defreezing” and final payment is made after the termination of media-concert in view of value of pleasure received by the consumer;
a calculation and payment of cost of services of the media-organizer, for example, provider;
processing of the current emotional state of consumers and giving to the artist of the total diagram of emotional state of audience change, including various attributes of approval or disapproval by audience of the current performance, for example, “applause”, “encore!”, “bravo!”, “bouquets of flowers”, “whistle”, “stamping by legs”, “rotten eggs” and etc.;
changes of the content of timetable by the artist depending on the current emotional state of the audience; and
changes of the scenario in real time mode with giving of changes to the artist by the way which is imperceptible for audience, for example, by using headphones, video-projectors, prompters, switching on beforehand prepared identical artist (real or virtual), using the records previously made.

40. The system of claim 1, wherein the subsystem of revealing and forecasting of the nearest requirements of the user includes items:
fixing current ESP;
fixing physical state, for example, user lies, sits, goes and etc.;
fixing a time of the day;
fixing kind and character of consumed media content;
fixing said characteristic words;
an analysis of previous items and results comparison with the typical displays of the user in life recorded earlier; and
giving out a signal to the user about coming soon need.

41. The system of claim 1, wherein the subsystem of control of the speed and content of transmitted media-product includes items:
fixing current ESP;
cuttings superfluous media constructs out;
a library of inserted media constructs;
an insert of additional media constructs; and
manual control of cutting out operations, insertion and repetition of media constructs.
